(19) United States
(12) Patent Application Publication
(10) Pub. No.: US 2025/0206467 A1
(43) Pub. Date: Jun. 26, 2025

(54) METHODS AND SYSTEMS FOR ARTIFICIAL INTELLIGENCE (AI) TAGGING OF AIRLINE FAULT CODES

(71) Applicant: AIXI, Inc., Raleigh, NC (US)

(72) Inventors: Cameron Byrd, Raleigh, NC (US); Matthew Fisher, Raleigh, NC (US)

(21) Appl. No.: 18/989,823

(22) Filed: Dec. 20, 2024

Related U.S. Application Data
(60) Provisional application No. 63/613,954, filed on Dec. 22, 2023.

(51) Int. Cl. B64F 5/60; G06F 40/30; G06N 3/045

(52) U.S. Cl. CPC B64F 5/60; G06N 3/045; G06F 40/30

(57) ABSTRACT

The subject matter described herein includes methods, systems, and computer program products for AI tagging of airline fault codes. According to one method, a transformer-based natural language processing (NLP) artificial intelligence (AI) model trained on a dataset is provided. The training dataset includes a plurality of text strings tagged with at least one associated air transport association (ATA) code. The trained AI model then receives an untagged text string as input and automatically tags the text string with an ATA code.

### CROSS-REFERENCE TO RELATED APPLICATIONS

This application claims priority to U.S. Provisional Patent Application No. 63/613,954 filed on Dec. 22, 2023, by AIXI Inc., entitled “METHODS AND SYSTEMS FOR ARTIFICIAL INTELLIGENCE (AI) TAGGING OF AIRLINE FAULT CODES,” the entire contents of which is incorporated by reference herein.

### BACKGROUND

### Field of the Invention

The present invention relates to the creation and management of airline fault codes associated with aircraft diagnostics, repair, and maintenance, and more specifically, to AI tagging of airline fault codes.

### Description of Related Art

Diagnosis, repair, and maintenance of aircraft typically involves users providing a written indication of an issue or fault. For example, a visual inspection by a ground crew member may indicate a defective wheel tire tube in the main landing gear of an aircraft. The ground crew member may prepare a report further indicating the manufacturer name, tube type and size of the defective wheel tire tubes. While these reports may be entered digitally using a client device, such as a mobile phone or tablet, they often are handwritten in physical logbooks.

No standard exists for writing reports of issues with an aircraft. For example, spelling, abbreviations, or other conventions may vary between individual users, between different airlines, and/or over time. In order to organize these reports, a system of tagging or associating each report with a standardized code was developed by the Air Transport Association (ATA).

ATA codes are a numerical technical classification of the systems and sub-systems on an aircraft and ATA codes are used in aircraft engineering and aircraft maintenance. The most common set of codes is the ATA Specification 100 codes. Currently, ATA codes use a four-digit format where the first two digits indicate a category (e.g., 31xx Instruments, 32xx Landing Gear, 33xx Lights, etc.) and where the last two digits indicate a specific issue in that category (e.g., 3234 Landing Gear Selector, 3251 Steering Unit). The ATA codes may include ten or more digits.

Even after tagging, conventional methods for storing and managing downstream dataflows associated with each reported aircraft issue have several disadvantages. One disadvantage includes an inability to generate insights across one or more dimensions. For example, it may be difficult or impossible for an airline to determine which aircraft (or type of aircraft) is associated with the most issues, whether a particular issue is common across a fleet of different aircraft, or whether any other patterns exist. It may also be difficult or impossible to accurately predict when a particular issue is likely to occur or what action is most likely to resolve a particular issue. This makes ordering parts in response to reported issues more expensive and time consuming, and can lead to extended downtime of aircraft, which can cost airlines significant amounts of money.

Accordingly, a need exists for improved methods and systems for automatically tagging user-generated reports of an aircraft issue or fault with a correct ATA code.

### BRIEF SUMMARY

The subject matter described herein includes methods, systems, and computer program products for AI tagging of airline fault codes. According to one method, a transformer-based natural language processing (NLP) artificial intelligence (AI) model trained on a dataset is provided. The training dataset includes a plurality of text strings tagged with at least one associated air transport association (ATA) code and one or more corresponding data codes. The trained AI model then receives an untagged text string as input and automatically tags the text string with an ATA code and/or additional codes, labels, or tags.

### BRIEF DESCRIPTION OF THE SEVERAL VIEWS OF THE DRAWINGS

FIG. 1 depicts an exemplary process flow for a method for AI tagging of airline fault codes according to an embodiment of the subject matter described herein.

FIG. 2 depicts an exemplary process flow for a method for AI tagging of airline fault codes according to an embodiment of the subject matter described herein.

FIG. 3 depicts a system for AI tagging of airline fault codes according to an embodiment of the subject matter described herein.

FIG. 4 depicts an exemplary process for initial training of the language model for coding ATA codes.

FIG. 5 depicts an example dataset for AI tagging of airline fault codes according to an embodiment of the subject matter described herein.

FIG. 6 depicts an exemplary process for fine-tuning the trained language model into a specific object code model.

FIG. 7 depicts an exemplary process for fine-tuning the trained language model into a specific fault ATA model.

FIG. 8 depicts an exemplary process for fine-tuning the trained language model into a specific failure mode model.

FIG. 9 depicts an exemplary process for fine-tuning the trained language model into a specific action model.

FIG. 10 depicts an exemplary process for fine-tuning the trained language model into a specific fix ATA model.

FIG. 11 depicts an exemplary process for tagging provided data using the fine-tuned models to generate predicted values for object code, failure mode, action, fault ATA, and fix ATA.

FIG. 12 depicts an example untagged text string and an exemplary AI tagging result provided by a trained AI model according to an embodiment of the subject matter described herein.

FIG. 13 depicts an exemplary dataset used for determining a final fix.

FIG. 14 depicts an exemplary process for determining a final fix.

FIG. 15 depicts an exemplary process for determining a final fix for a given combination of fault ATA code, object, and/or failure mode.

FIG. 16 depicts an exemplary process for determining a final fix that combines multiple statistical methods according to an embodiment of the subject matter described herein.

FIG. 17 depicts an example of a user interface showing the determination of a final fix according to an embodiment of the subject matter described herein.

FIG. 18 depicts an exemplary process for determining predictive analytics using one or more of a predicted object code, a predicted failure mode, and/or predicted fault ATA code.

### DETAILED DESCRIPTION

The subject matter described herein includes AI-based methods and systems for automatically tagging user-generated reports of an aircraft issue or fault with a correct air transport association (ATA) code and/or one or more human-readable codes, as well as additional diagnostic information related to the ATA code or the human-readable codes. From one or more text descriptions of an issue (e.g., a fault and/or a fix), the subject matter described herein generates a fault ATA code (which codes the issue), a fix ATA code (which identifies a fix for the issue identified by the fault ATA code), a failure mode (which describes a source of the issue identified by the fault ATA code), an object code (which adds specificity to the fix ATA code), and an action code (which describes an action to be taken to address the issue identified by the fault ATA). In contrast to conventional configurations, which rely on manually tagging airline faults codes, the present disclosure uses one or more transformer-based natural language processing (NLP) artificial intelligence (AI) models that are trained on a domain-specific dataset that includes correct and verified fault/fix information (i.e., object code, failure mode, action code, fault ATA, and fix ATA) for various user-generated aircraft fault reports. For example, the training dataset includes a plurality of combinations of tagged fault text and fix text, where each combination includes at least a fault text string and a fix text string. After training the model, the trained model may be provided with a new, untagged text string comprising fault text and/or fix text as input, where the new, untagged text string is not from the training dataset. The AI model then automatically determines fault/fix information (i.e., object code, failure mode, action code, fault ATA, and fix ATA) associated with the text string. In addition, the AI-based methods and systems described herein can provide and/or automate additional functions such as, but not limited to, identifying a “final fix” for an identified problem, predicting when a part is likely to fail, and proactively ordering a replacement part as part of a just-in-time inventory management system.

Thus, the subject matter described herein improves safety, reduces downtime, optimizes costs, and increases customer satisfaction. By empowering users with artificial intelligence unlocking insights embedded in their data, they can discover, justify and implement operational optimizations, take control of unplanned maintenance by predicting failures, and identify the root cause of the problem to fix it right the first time. Using the systems and method described herein to extract actionable intelligence can predict failures, optimize processes, and anticipate needs, which leads to reduced costs and a better user experience.

For example, using artificial intelligence, the subject matter described herein helps airlines classify and analyze a wide range of mechanics' notes for identifying the root cause of unexpected component failures. This improves safety and reduces the costs incurred by delays and cancelations. The subject matter described herein also helps companies analyze their logistics and supply chains, increasing visibility with supply-demand forecasting and product distribution processes. Systems and methods described herein classify, translate, and transform repair/maintenance records of large machinery (such as aircraft), providing important contextual information for repairs, rebuilding, inspections, modifications, quality control, and safety purposes.

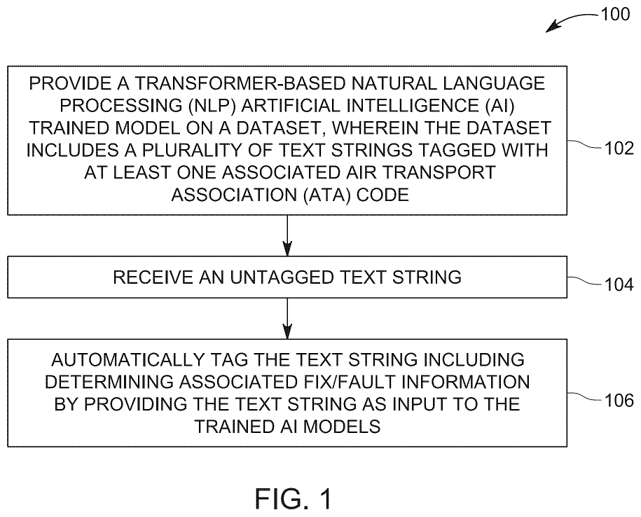

FIG. 1 depicts an exemplary method for AI tagging of airline fault codes according to an embodiment of the subject matter described herein.

The method includes, at step 102, training a transformer-based natural language processing (NLP) artificial intelligence (AI) model on a dataset, wherein the dataset includes a plurality of tuples, each tuple including at least a text string and an associated air transport association (ATA) code.

An artificial intelligence (AI) model is a program that analyzes datasets to find patterns and make predictions. Training an AI model is the process of teaching the model to properly interpret data, and learn from it, in order to perform a task with accuracy. Here, one such task includes accurately tagging mechanic notes associated with repair/maintenance records of large machinery (e.g., aircraft) with the correct ATA code.

Training the AI model may include one or more of the following steps: initial training, validation, and testing. In the initial training step, an untrained AI model is given a set of training data and asked to make decisions based on that information. Accurate, complete, and normalized training data is an important factor in the success of training an AI model and may be an expensive and time-consuming process on its own.

Once initial training is completed, the expected performance of the (partially) trained AI model is validated using a new set of data that is not part of the training data. During this stage, model parameters may be adjusted. This process may be iterative where the performance of the model may be evaluated, adjusted, and tested multiple times on the same training data set and/or multiple, different training data sets. Finally, the trained AI model may be tested on target input that corresponds with real world input the AI model is intended to make accurate decisions on.

Here, for example, the training dataset may be composed of manually tagged, normalized, and verified fault/fix combinations associated with a desired standard format for associating various values used within the airline industry for reporting aircraft issues. The training dataset may also exclude words or other parameters associated with general purpose language tasks because they are unlikely to be included in aircraft repair/maintenance records or associated with ATA codes. For example, each fault/fix combination in the training dataset may include an associated date, an aircraft classification number (ACN), a fleet identifier, a model identifier, a fault identifier, a barcode, a page number in a logbook, an ATA discrepancy type code, a text description of the discrepancy (i.e., the fault text), a text description of a fact (i.e., the fix text), a known ATA code associated with the discrepancy or fault text, a known object code associated with the fault/fix combination, a known failure mode associated with the fault/fix combination, a known action code associated with the fault/fix combination, and a known fact ATA code associated with the fact of fix text.

Training the AI model may be performed once, and the resulting trained AI model may be replicated across one or more devices. Because the training dataset may be large, requiring a large amount of computer memory, and the process of training the model may be computationally expensive, training may be performed on one or more servers rather than on a client device.

After training, the trained model may require less computer memory and be significantly less computationally expensive to execute. As such, an instance or copy of the trained model may be stored locally on one or more client devices. In other embodiments, the trained model may be stored remotely and accessed by the one or more client devices, such as in a cloud or Software-as-a-Service environment.

The method includes, at step 104, receiving an untagged text string. In one embodiment, the untagged text string may be a sequence of characters stored digitally representing a fault (discrepancy) and/or a fix (fact). For example, a mechanic may use a client device, such as a mobile phone or tablet, to type notes associated with repair/maintenance records of large machinery (e.g., aircraft).

In another embodiment, notes may be handwritten on physical sheets of paper. Optical character recognition (OCR) may be used on captured images of the notes to transform handwritten notes into a digital format for use by the AI model.

In yet another embodiment, notes may be handwritten (rather than typed) directly in a digital format. For example, a user may use a stylus and a mobile device to hand write notes using a digital interface. The user's handwriting may be automatically translated into a standardized string of characters without first having to scan a physical piece of paper.

It is appreciated that the received untagged text string may be more likely to have one or more features than a random text string selected from a general-purpose English language corpus. For example, because the received untagged text string is expected to be produced by a mechanic or similar user and is expected to relate to repair/maintenance records of large machinery (e.g., aircraft), the received untagged text string may have a vocabulary that is more focused on this subject matter (e.g., fewer words related to non-aircraft topics and more words related to aircraft topics), may have a shorter length than an average sentence, may have more abbreviations than an average sentence, and may have different or less punctuation than an average sentence.

The method includes, at step 106, automatically tagging the received untagged text string by providing the text string as input to the one or more trained AI models.

For example, an untagged text string may include “tire mlg.” Based on its knowledge, gained through training and embodied as AI models, the models may determine that “mlg” is an abbreviation often used in notes associated with repair/maintenance records of aircraft to refer to “main landing gear.” Additionally, the models may determine that “tire” most often refers to reports of defective wheel tire tubes rather than reports of tire defects and failures. The models may then also determine that the main landing gear identifies the location of the tire in the “Part Location” field of the report. Finally, the models may determine that the correct fault ATA code to associate with the text string is ATA code 3245 (Tire Tube) rather than ATA code 3244 (Tire), where the first two digits of the code “32” refer to all issues with all landing gear, and the last two digits of the code “45” vs “44” refer to different types of tire issues within the landing gear category.

Additional ATA codes, or other associated data, may also be determined by the models. For example, fix ATA code 3245 may be most likely associated with a particular failure mode (e.g., “worn” tires), a particular object code (e.g., main tire/wheel assembly), and a particular action (e.g., “replaced”). Thus, from the text string “tire mlg,” the AI models may automatically determine that the issue identified by this text string relates to a worn wheel tire tube on the main tire of the main landing gear that was or should be replaced.

In one embodiment, the text string is a natural language description of a problem with an aircraft, which may be comprised of a combination of a fault (discrepancy) text and/or a fix (fact) text. While the above example contains the abbreviation “mlg,” has no punctuation, and is not a complete sentence, other text strings are also possible. For example, a natural language description may include multiple complete sentences and punctuation in a narrative form.

In one embodiment, the method further includes determining one or more possible fixes as fix ATA codes for the issue associated with the determined fault ATA code by providing the fault ATA code as input to the trained AI models, determining a fix ATA code for each possible fix, a probability that the possible fix has a standard deviation of one above all other possible fixes, and identifying the possible fix having the highest probability, from among the one or more possible fixes, as a suggested fix.

In one embodiment, the one or more possible fixes and their associated probabilities are displayed on a client device.

In one embodiment, the method further includes determining the probability that a system or component associated with the received fault ATA code is likely to fail within a predefined time period.

In one embodiment, the method further includes automatically ordering one or more items, parts, services, components, or systems based on the determined probability of failure or the determined probability of needing a particular replacement part based on the fault ATA code and the corresponding fix ATA code.

In one embodiment, the method further includes at least one of escalating or de-escalating a service interval based on the determined probability of failure.

In one embodiment, receiving an ATA code includes receiving a set of ATA codes associated with a fleet composed of one or more aircraft. This enables fleet-wide trends and/or patterns to be identified. For example, the system may determine that all aircraft of a particular type have a main landing gear failure more frequently than other types of aircraft within the fleet.

In one embodiment, the method further includes generating a report, wherein the report identifies a subset of the ATA codes satisfying a predefined criterion.

In one embodiment, the predefined criterion includes ATA codes in the fleet having a value above a threshold value.

In one embodiment, the dataset is associated with a specific airline.

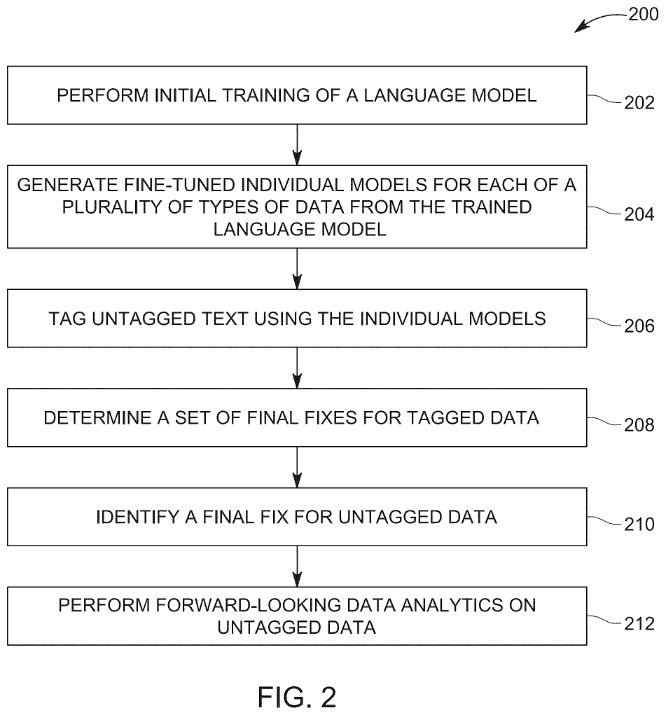

FIG. 2 depicts an exemplary process flow for a method for AI tagging of airline fault codes according to an embodiment of the subject matter described herein.

At step 202, a language model is initially trained. The initial training trains the model on commonly used language in airline fault code records. To train a language model based on the domain-specific dataset of airline fault code records, the process may begin by selecting an appropriate transformer architecture, such as BERT (Bidirectional Encoder Representations from Transformers), RoBERTa, or DistilBERT. The model may understand contextual relationships in text, which may be used for interpreting user-generated reports that may contain technical jargon, abbreviations, and varied linguistic styles. By leveraging a pre-trained model, the initial training process may be accelerated due to the foundational language understanding already encoded in the model.

In the initial training phase, the pre-trained model may be adapted by further training it on domain-specific data to capture the unique linguistic patterns and terminology used in aviation maintenance reports, such as technical terms, acronyms, and domain-specific language prevalent in these reports. This adaptation may involve tokenizing the text inputs using the same tokenizer associated with the selected pre-trained model. The tokenizer's vocabulary may be extended to include these terms to prevent them from being broken into subword units that could obscure their meaning. This step may ensure consistency in how text is represented within the model and may enhance its ability to understand and process domain-specific inputs.

At step 204, individual fine-tuned models are generated from the trained language model using known tagged data. In an embodiment, five different fine-tuned models are generated, one for each of the following pieces of fix/fault information: (1) object code; (2) fault ATA; (3) failure mode; (4) action; and (5) fix ATA.

Fine-tuning may be performed using known tagged data to optimize the model's performance on the specific classification task. Label encoding may be a component of this step. In one embodiment, the ATA codes and additional tags may be transformed into numerical formats that the model can process. This may involve creating a mapping from each unique code to an integer index or using one-hot encoding for multi-label scenarios. It may be ensured that this encoding is consistent across training, validation, and test datasets to maintain the integrity of the learning process.

During the fine-tuning phase, the model may learn to minimize a loss function that quantifies the difference between its predictions and the actual labels. For multi-label classification tasks, the binary cross-entropy loss function may be used in conjunction with sigmoid outputs. For single-label classification, the cross-entropy loss function paired with softmax outputs may be appropriate. The optimizer may be chosen for efficient convergence, adjusting the model's weights based on the gradients computed from the loss function and moving the model parameters toward values that reduce the loss.

Hyperparameter tuning may be used to optimize the model's performance during fine-tuning. An initial learning rate may be set, controlling the step size during optimization. The learning process may be monitored to adjust the learning rate if necessary. The batch size, determining how many samples may be processed before the model's weights are updated, may also affect training stability and resource consumption.

The number of training epochs—the number of times the model iterates over the entire training dataset—may be determined by observing the model's performance on a validation set. Early stopping mechanisms may be implemented to mitigate overfitting by halting training when the validation loss stops improving. Regularization techniques such as dropout, which randomly deactivate a fraction of the neurons during training, may also prevent the model from becoming too reliant on any single feature or pattern in the data. Throughout the fine-tuning process, the model's performance may be evaluated using appropriate metrics.

At step 206, untagged data is tagged using the individual fine-tuned models. For example, after the initial model training and fine-tuning have been performed, new, untagged data may be input into the trained and fine-tuned models to automatically associate the text entries with the correct fault ATA codes. The process may begin by receiving a text entry from an aircraft maintenance logbook that requires tagging.

In one embodiment, the new text data may be preprocessed using the same tokenization and normalization methods employed during the training phase. This may involve converting the text to a consistent case, handling abbreviations and acronyms, and applying the tokenizer associated with the transformer model.

Once the text data has been preprocessed, it may be fed into the trained model for inference. The model may generate a set of predictions in the form of probabilities or confidence scores for each possible ATA code. For multi-label classification tasks, the model may output a probability for each ATA code independently, indicating the likelihood that the code is relevant to the input text.

Thresholding may then be applied to these probabilities to determine which ATA codes should be assigned to the text entry. In one embodiment, a predefined confidence threshold may be set, and any ATA codes with probabilities exceeding this threshold may be selected. Alternatively, a predetermined number of ATA codes with the highest probabilities may be chosen. The selected ATA codes may then be associated with the text entry, effectively tagging it with the appropriate fault codes.

At step 208, a set of final fixes is determined using tagged data. For example, the models may determine that “tire” in a given context may refer to defective wheel tire tubes or tire defects or associated with a failure mode of worn tires.

Possible fixes may include replacing the worn wheel tire tube on the main tire of the main landing gear. Additional possible fixes may also be identified by the models. These may include inspecting the tire for damage, checking tire pressure, or performing maintenance on related components of the main landing gear. The AI models may generate a list of recommended actions based on historical data, manufacturer guidelines, and regulatory requirements.

At step 210, a final fix is identified for untagged data.

In one embodiment, determining whether a fix is a final fix includes employing survival analysis techniques. This involves fitting a survival model, such as the Kaplan-Meier estimator, to historical fix lifetime data associated with the determined fault ATA code. The survival probability at the current fix lifetime is calculated, and if this probability falls below a predefined threshold (e.g., 5%), the fix is identified as a final fix.

In another embodiment, determining whether a fix is a final fix includes utilizing a Cox proportional hazards model. The model may be trained on historical fix data, incorporating various features such as fix type, aircraft age, environmental conditions, and usage patterns. By calculating the hazard ratio for the current fix and estimating its survival probability over time, the method identifies the fix as final if the survival probability at the current fix lifetime is below a chosen threshold.

In another embodiment, determining whether a fix is a final fix includes applying clustering techniques to historical fix data. By clustering fixes based on their lifetimes and other relevant features, the method identifies groups representing final and non-final fixes. The current fix is then assigned to a cluster, and if it belongs to the cluster associated with final fixes (e.g., the cluster with the longest average fix lifetime), it is identified as a final fix.

In another embodiment, determining whether a fix is a final fix includes employing an Isolation Forest-based anomaly detection technique. The method involves combining the fix lifetime with other relevant features to form feature vectors representing each historical fix. An Isolation Forest model is trained on this historical data to learn the normal patterns of fix lifetimes and associated features. The current fix is then evaluated using the trained model to compute an anomaly score and determine if it is an outlier. If the fix is identified as an outlier—deviating significantly from historical patterns—it is considered a final fix.

In another embodiment, determining whether a fix is a final fix includes utilizing Bayesian statistical methods wherein domain knowledge sets the prior distribution. The method involves defining a prior distribution of expected fix lifetimes based on domain knowledge, such as manufacturer guidelines or expert input on operational lifetimes for parts and systems associated with the fault ATA code. Historical fix lifetime data is then used to update this prior distribution, forming a posterior distribution that reflects both prior expectations and observed data. By calculating the probability that the fix lifetime exceeds the observed duration using the posterior distribution, the method identifies the fix as final if this probability is below a chosen threshold (e.g., 5%).

In another embodiment, determining whether a fix is a final fix includes utilizing time series analysis. By analyzing the sequence of past fix events and modeling the intervals between them using time series models (e.g., ARIMA), the method forecasts the expected time until the next fix. If the time elapsed since the last fix significantly exceeds this forecasted interval (e.g., by 50%), the fix is identified as final.

In another embodiment, determining whether a fix is a final fix includes employing an ensemble approach that combines multiple statistical methods previously described. Each method generates an individual prediction regarding the finality of the fix. This ensemble method enhances the robustness and adaptability of the final fix determination by leveraging the strengths of multiple statistical approaches and incorporating user feedback. As more feedback is collected over time, the weights can be updated to improve the overall accuracy and reliability of the ensemble prediction.

The ensemble method may begin by computing individual predictions from various statistical approaches. Weights may be retrieved for each statistical method (e.g., based on user feedback accumulated over time where this feedback reflects the historical accuracy, reliability, or user preference for each method) and the weights may be normalized to ensure they sum to one. Initial weights (prior to collecting user feedback) may be chosen via optimizing the fit to historical fix data.

The individual predictions may then be aggregated by calculating a weighted vote, where each prediction is multiplied by its corresponding weight derived from user feedback.

A decision threshold may be set for classifying the fix as final or not. In one embodiment, the fix may be identified as a final fix if the weighted vote meets or exceeds the threshold (e.g., 0.5 in a binary classification scenario).

The final determination may then be output based on the aggregated, weighted predictions.

At step 212, forward-looking data analytics are performed on untagged data.

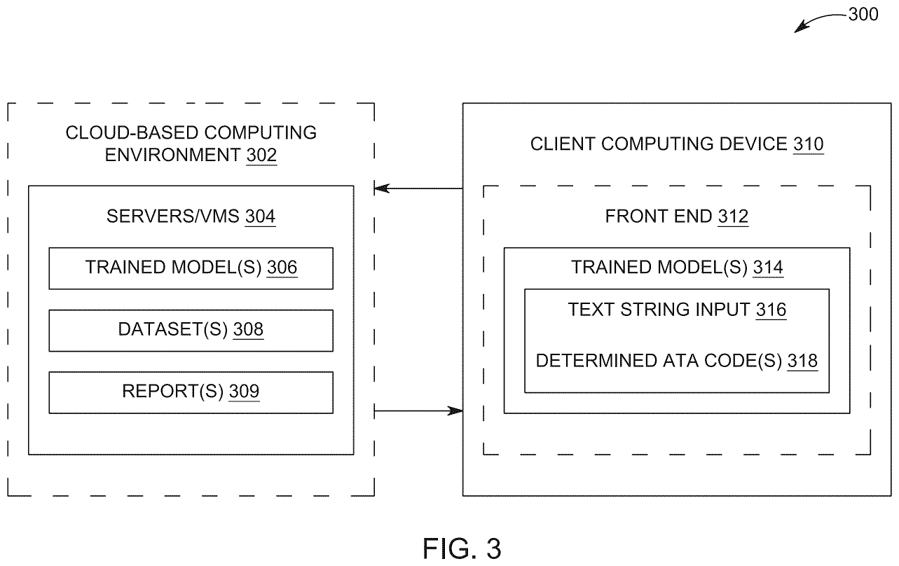

FIG. 3 depicts a system 300 for AI tagging of airline fault codes according to an embodiment of the subject matter described herein. The back-end server 304 may be implemented on one or more physical servers implemented within cloud-based computing environment 302. The back-end server 304 may include a non-transitory computer readable medium including a plurality of machine-readable instructions which when executed by one or more processors of the one or more servers are adapted to cause the one or more servers to perform a method of organization network analysis. The methods may include the methods described in FIGS. 1 and 2.

Thus, the system disclosed herein may be implemented as a client/server type architecture, but may also be implemented using other architectures, such as cloud computing, software as a service model (SaaS), a mainframe/terminal model, a stand-alone computer model, a plurality of non-transitory lines of code on a non-transitory computer readable medium that can be loaded onto a computer system, a plurality of non-transitory lines of code downloadable to a computer, and the like.

In one embodiment, the system 300 includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system 300, the user may use a front-end client application 312. The client application may communicate with a back-end cloud component using an application programming interface (API) or other means.

The back-end cloud component 304 described herein may also be referred to as a SaaS component. One or more tenants may communicate with the SaaS component via a communications network, such as the Internet. The SaaS component may be logically divided into one or more layers, each layer providing separate functionality and being capable of communicating with one or more other layers.

In one embodiment, the trained model is replicated across one or more physical or virtual computing devices. In another embodiment, the trained model is stored locally on a client device. In yet another embodiment, the trained model is stored remotely in a cloud computing environment and accessed by a client device as a service.

In one embodiment, training the model on the dataset includes separating the dataset into one or more ATA code-specific dataset, creating a separate instance of the model for each ATA code, and individually training each instance of the model on each of the ATA code-specific datasets.

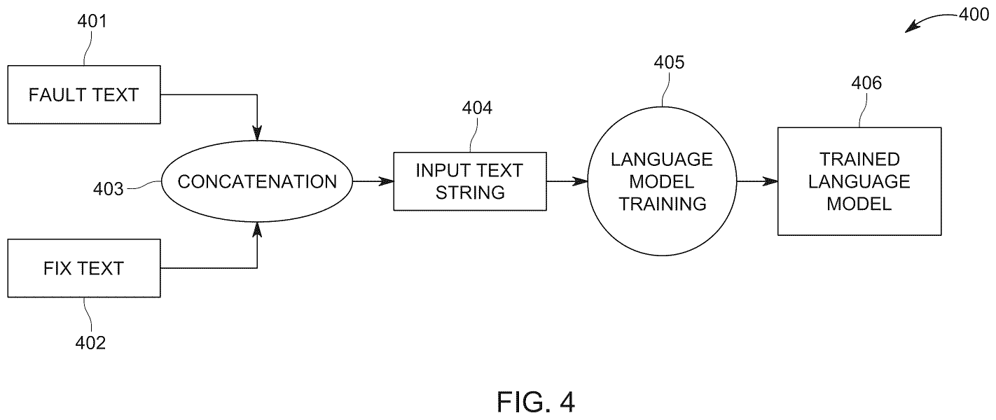

FIG. 4 depicts an exemplary process for initial training of the language model for coding ATA codes. Referring to FIG. 4, the system or method receives text input. The text input includes a plurality of fault text 401 and fix text 402 pairs or combinations. Each fault text 401 and fix text 402 pair/combination may have been previously tagged with an associated fault ATA code, fix ATA code, failure mode, object code, and/or action code. In an embodiment, each fault text 401 and fix text 402 pair/combination may be concatenated (process 403) into a single input text string 404. A generic AI language model is trained (process 405) using the fault text and fix text pair/combinations, and in some embodiments, may also use their associated fault ATA code, fix ATA code, failure mode, object code, and/or action code. The language model training produces trained language model 306.

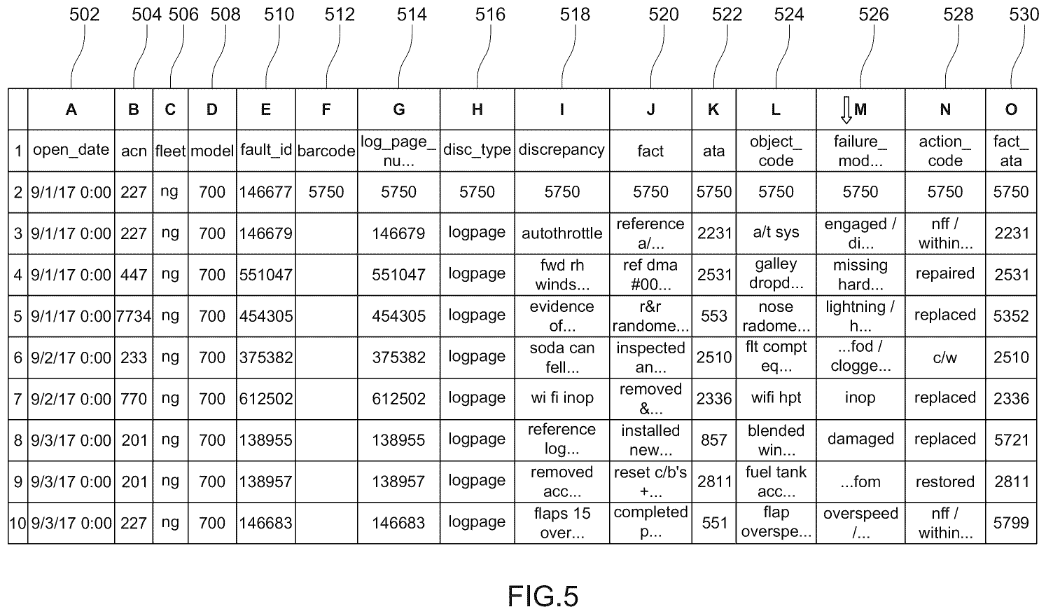

FIG. 5 depicts an example dataset for AI tagging of a set of airline fault codes according to an embodiment of the subject matter described herein. Referring to FIG. 5, the dataset, which may be used for training one or more AI models, may include a domain-specific dataset that includes one or more ATA codes or other data included in or associated with one or more user-generated aircraft fault reports. For example, the training dataset may include a plurality of combinations of fault (discrepancy)/fix (fact) text descriptions, where each fault/fix combination includes at least a text string. Here, each fault/fix combination corresponds to a row, and each column refers to a different data type for individual elements in a tuple.

In the embodiment shown in FIG. 5, each fault/fix combination may include a date 502, an aircraft classification number (ACN) 504, a fleet identifier 506, a model identifier 508, a fault identifier 510, a barcode 512, a page number in a logbook 514, a discrepancy type 516, a text description of the discrepancy (fault) 518, a fact (fix) 520, an associated discrepancy (fault) ATA code 522, an object code 524, a failure mode 526, an action code 528, and an associated fact (fix) ATA code 530.

In the example shown, the date 502 includes a date and time in a standardized and/or normalized format indicating when the entry was created (e.g., the issue was opened and recorded in a logbook). ACN 504 identifies a particular aircraft in an alphanumeric sequence.

Here, multiple entries are associated with ACN “227” whereas only one entry is associated with ACN “770”, potentially indicating that aircraft “227” is more likely to require repair or maintenance than aircraft “770.” Fleet identifier 506 “ng” is associated with all the entries which indicates that all aircraft listed by ACN 604 are part of the same fleet (e.g., Boeing 737 Next Generation (NG)). Model identifier 508 identifies the model number of each aircraft (e.g., Boeing 700 series). Fault identifier 510 may be a six-digit number (or another number of digits, in various embodiments) indicating a particular fault. Barcode 512 may be used for scanning by a barcode reader, if applicable. The logbook page number 514 indicates which page the entry can be found in a physical mechanic's logbook, if applicable.

The discrepancy (or fault) 518 provides a natural language or similar explanation of the problem so that a user does not have to remember the meaning of each ATA code. Here, for example, the text descriptions 518 describe various problems ranging from issues with the autothrottle, a soda can that fell somewhere it should not have, and Wi-Fi not operating correctly.

Fact (fix) 520 indicates an action corresponding to a potential fix of the issue identified by the discrepancy (fault). Here, for example, actions ranged from inspecting a part, removing a part, and resetting a circuit breaker.

Object code 524 provides more specificity to the fault or the fix. Here, for example, an existing Wi-Fi hotspot was removed and a new Wi-Fi hotspot was installed to address an inoperable Wi-Fi issue. Failure mode 526 describes how the device, equipment, or machine failed (e.g., damaged, clogged, missing, etc.).

Action code 528 describes what steps were performed to implement the fix indicated by the ATA fact code 520. This may include text descriptions or abbreviations such as repaired, replaced, or restored. Fact ATA code 530 may be the specific ATA code associated with fact description 520. Here, each potential fix or action taken may be associated with a different ATA fact code.

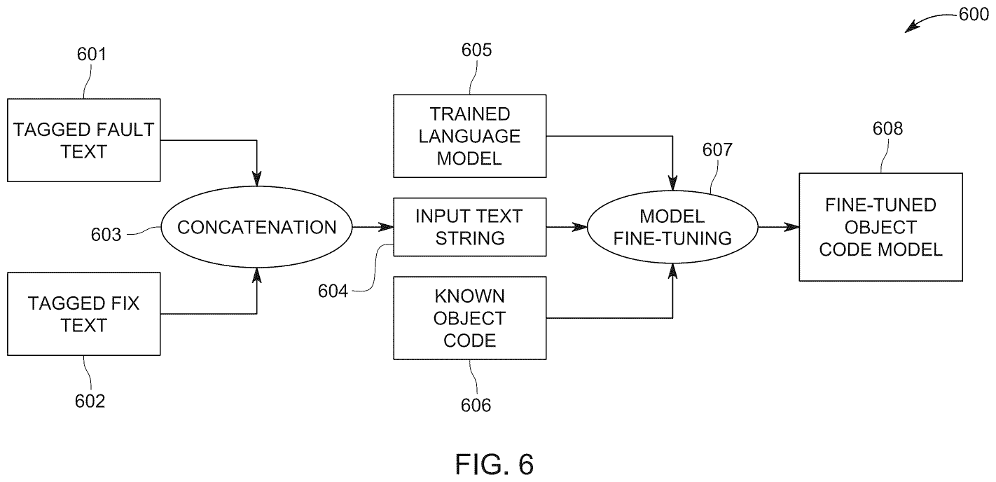

FIG. 6 depicts an exemplary process for fine-tuning the trained language model into a specific object code model. Referring to FIG. 6, the system or method receives text input. The text input includes a plurality of fault text 401 and fix text 402 pairs or combinations. Each fault text 401 and fix text 402 pair/combination has been previously tagged with an associated fault ATA code, fix ATA code, failure mode, object code, and/or action code. In an embodiment, each fault text 401 and fix text 402 pair/combination may be concatenated (process 403) into a single input text string 404. The fault text 401 and fix text 402 pairs/combinations are provided as input to model fine-tuning process 607, along with their associated known object codes 606 and the trained language model 406 (which was generated as described in the context of FIG. 4). The model fine-tuning process 607 generates a fine-tuned object code mode 608.

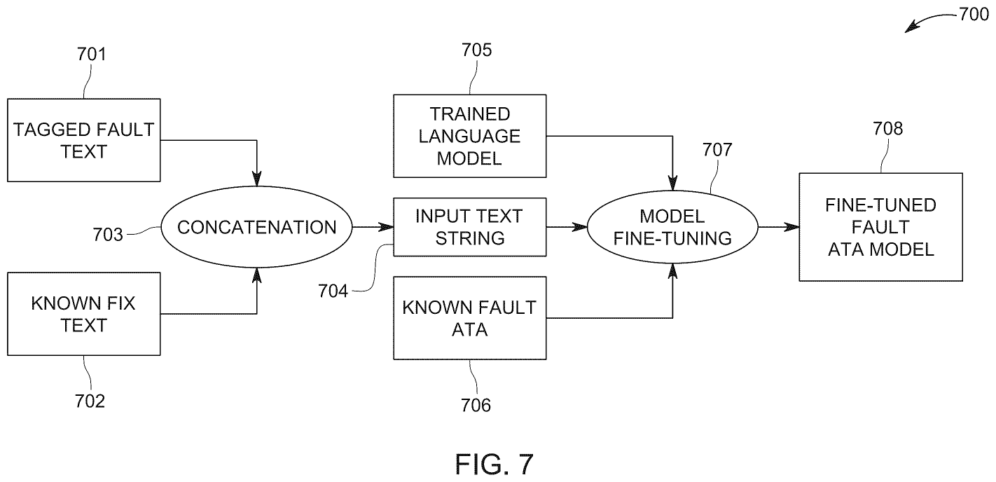

FIG. 7 depicts an exemplary process for fine-tuning the trained language model into a specific fault ATA model. Referring to FIG. 7, a fine-tuned fault ATA 718 is generated for fault ATA codes in a manner similar to that described in the context of FIG. 6.

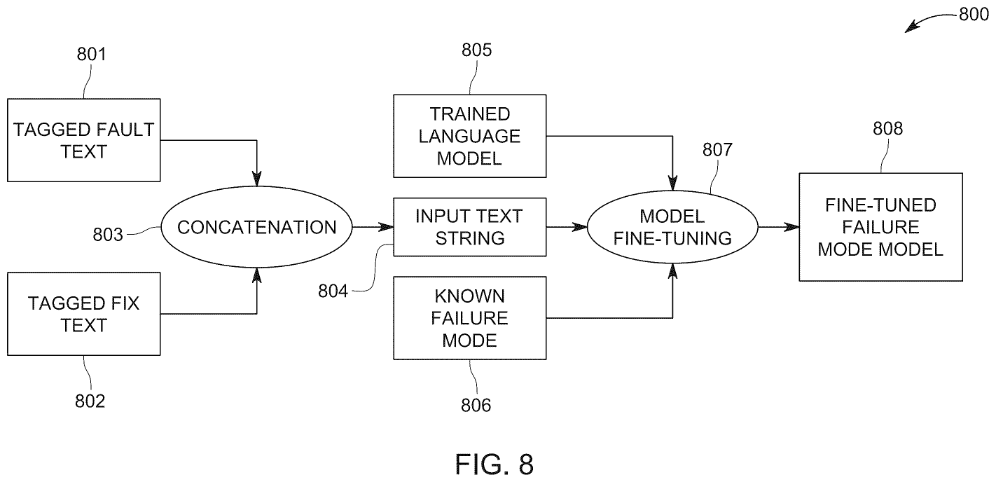

FIG. 8 depicts an exemplary process for fine-tuning the trained language model into a specific failure mode model. Referring to FIG. 8, a fine-tuned failure mode model 828 is generated for failure modes in a manner similar to that described in the context of FIG. 6.

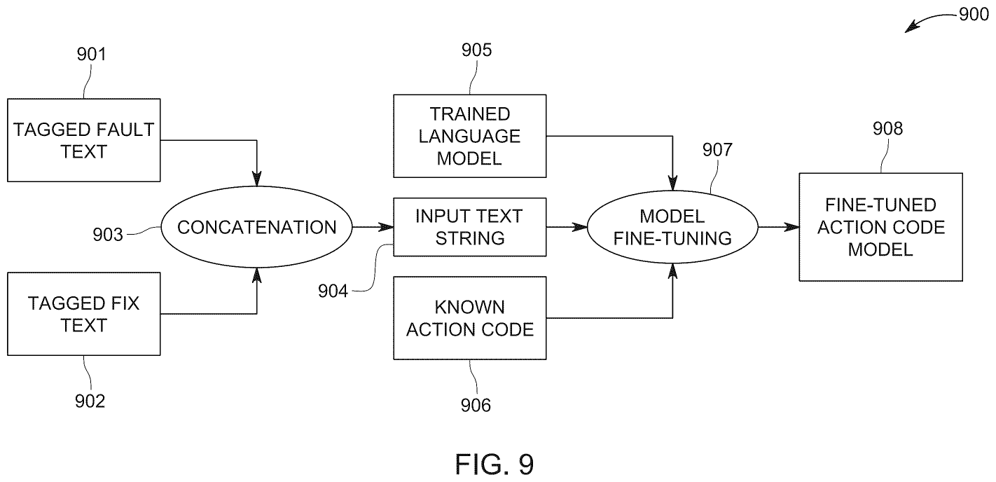

FIG. 9 depicts an exemplary process for fine-tuning the trained language model into a specific action model. Referring to FIG. 9, a fine-tuned action code model is generated for action codes in a manner similar to that described in the context of FIG. 6.

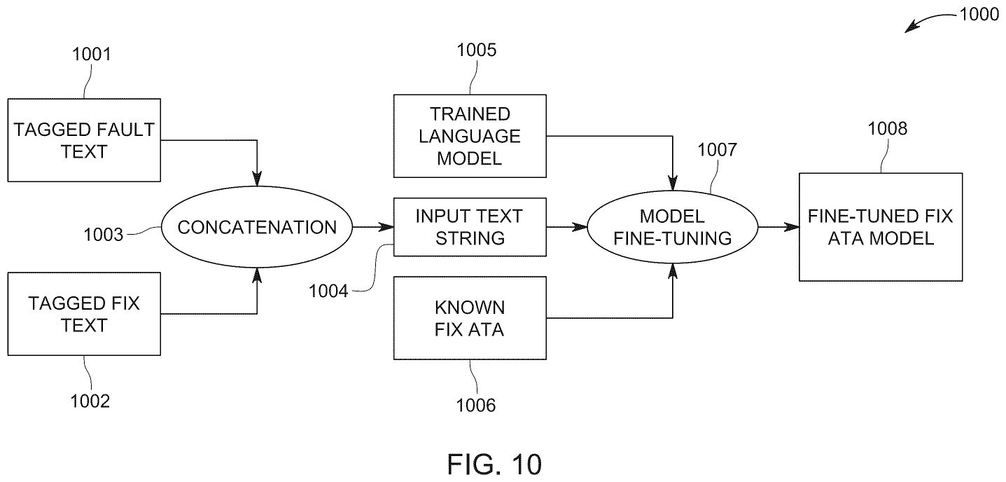

FIG. 10 depicts an exemplary process for fine-tuning the trained language model into a specific fix ATA model. Referring to FIG. 10, a fine-tuned fix ATA model is generated for fix ATA codes in a manner similar to that described in the context of FIG. 6.

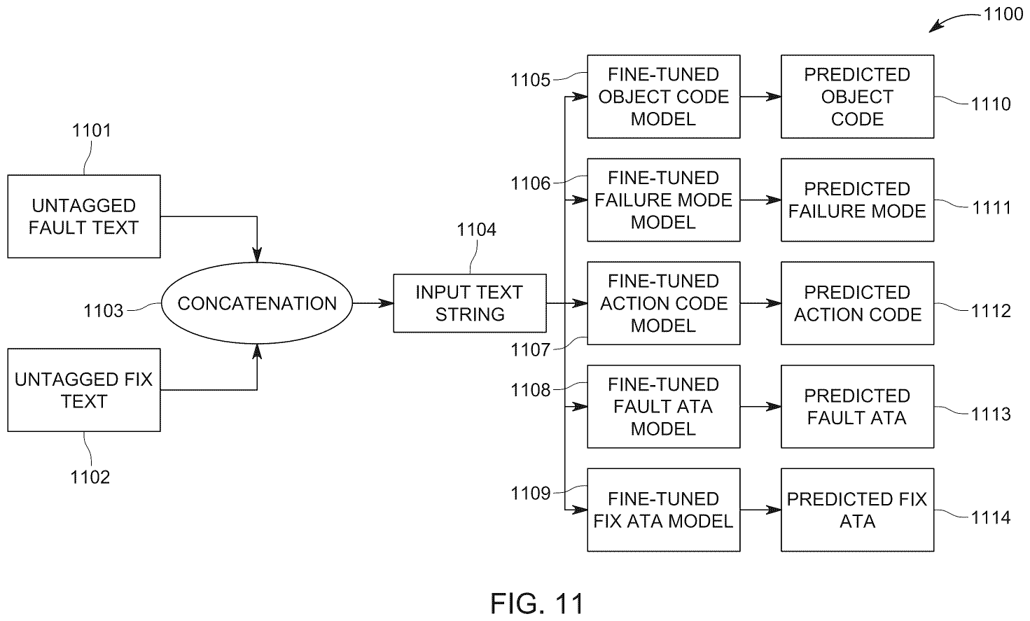

Thus, FIG. 11 describes an initial training process for training an AI language model on known fault and fix text. FIGS. 6-10 describe a fine-tuning process in which the trained language model is fine-tuned for five separate variables to generate five separate fine-tuned models, one for each of fault ATA code, fix ATA code, failure mode, object code, and action code.

FIG. 11 depicts an exemplary process for tagging provided data using the fine-tuned models to generate predicted values for object code, failure mode, action, fault ATA, and fix ATA. Referring to FIG. 11, fault text 1101 and fix text 1102 are provided as an input text string 904 to each of the five fine-tuned models. The fault text 1101 and fix text 902 are untagged, meaning that the fault ATA code, fix ATA code, failure mode, object code, and action code are unknown. The fine-tuned object code model takes the text string 1104 as input and determines a predicted object code 1105. The fine-tuned failure mode model takes the text string 1104 as input and determines a predicted failure mode 1106. The fine-tuned action code model takes the text string 1104 as input and determines a predicted action code 1107. The fine-tuned fault ATA model takes the text string 1104 as input and determines a predicted fault ATA code 1108. The fine-tuned fix ATA model takes the text string 1104 as input and determines a predicted fix ATA code 1109.

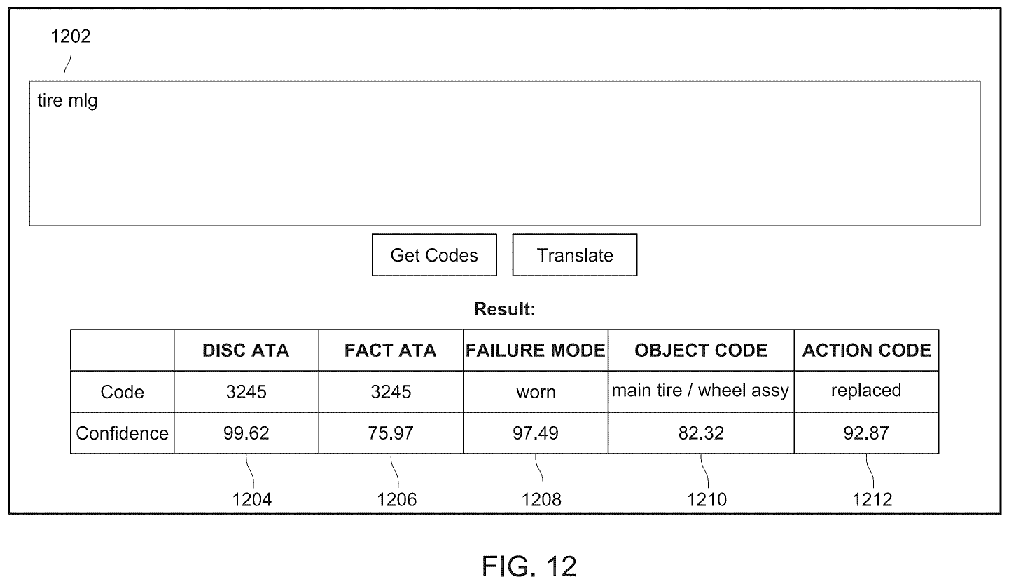

FIG. 12 depicts an example of an untagged text string and an exemplary AI tagging result provided by a trained AI model according to an embodiment of the subject matter described herein. Here, a front-end user interface may be provided on a client device for use by a user. The user may enter a fault/fix text string 1202 directly in a user input box. This text string 1202 may be provided to one or more AI models specifically trained, as described herein, to automatically tag the text with the correct fault/fix information, which includes a fault ATA code 1204, a fact ATA code 1206, a failure mode 1208, an object code 1210, and/or an action code 1212.

For example, text string 1202 includes “tire mlg.” Based on knowledge, gained through training and embodied in the trained AI models stored locally or accessed remotely, it may be determined that “mlg” is an abbreviation often used in notes associated with repair/maintenance records of aircraft to refer to “main landing gear.” Additionally, the model may determine that “tire” most often refers to reports of defective wheel tire tubes rather than reports of tire defects and failures. The model may then also determine that the main landing gear identifies the location of the tire in the “Part Location” field of the report. Finally, the models may determine that the correct fault ATA code to associate with the text string is ATA code 3245 (Tire Tube) rather than ATA code 3244 (Tire), where the first two digits of the code “32” refer to all issues with all landing gear, and the last two digits of the code “45” vs “44” refer to different types of tire issues within the landing gear category.

Additional ATA codes, or other associated data, may also be determined by the model. For example, fact ATA code 3245 may be most likely associated with a particular failure mode (e.g., “worn” tires), a particular object code (e.g., main tire/wheel assembly), and a particular action code (e.g., “replaced”). Thus, based on the text string 1202 “tire mlg,” the AI models may automatically determine that this relates to a worn wheel tire tube on the main tire of the main landing gear that was or should be replaced.

Results provided by the AI model may be presented to the user, along with a confidence score. Here, for example, the AI models determines with 99.62% confidence that the correct fault ATA code 1204 associated with input 1202 is “3245.” Similarly, the AI model determines with 75.97% confidence that the correct fact ATA code 1206 is “3245,” with 97.49% confidence that the correct failure mode 1208 is “worn,” with 87.32% confidence that the correct object code 1210 is “main tire/wheel assy,” and with 92.87% confidence that the correct action code 1212 is “replaced.”

As previously noted, the text string may be a natural language description of a problem with an aircraft. While the above example of a text string “tire mlg” contains an abbreviation, no punctuation, and is not a complete sentence, other text strings are also possible. For example, a natural language description may include multiple complete sentences and punctuation in a narrative form.

It may be appreciated that while some embodiments determine one or more types of information based on a received, untagged text string—most notably ATA code(s)—that the subject matter described herein may also be performed “in reverse” to determine one or more text strings or other data based on one or more known data points.

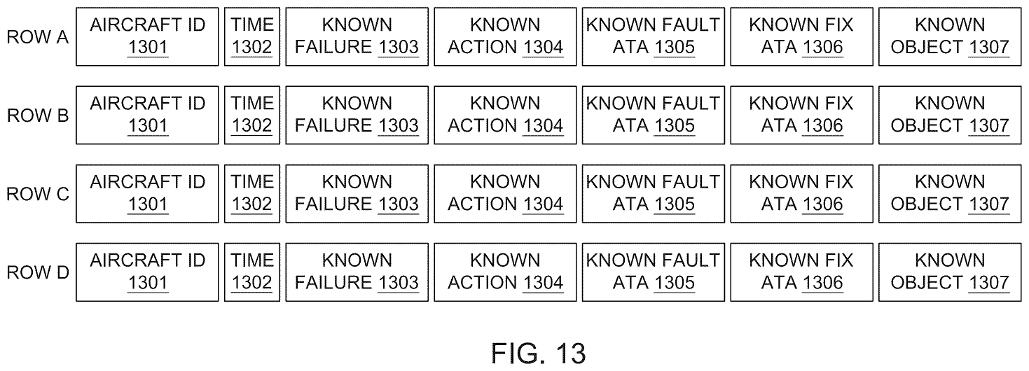

FIG. 13 depicts an exemplary dataset used for determining a final fix. Referring to FIG. 13, the dataset includes a plurality of rows of data, with each row of data including at least an aircraft ID 1301, a time 1302, a failure mode 1303, an action 1304, a fault ATA code 1305, a fix ATA code 1306, and an object code 1307.

In one embodiment, these are the same dataset as described in the context of FIG. 5. In other embodiments, these are a dataset of data that has been generated and tagged as described herein. A final fix may be determined from this dataset. The final fix refers to the identification of the fix that has been applied to a particular issue that, with the benefit of hindsight, can be seen to have resolved the issue as expected.

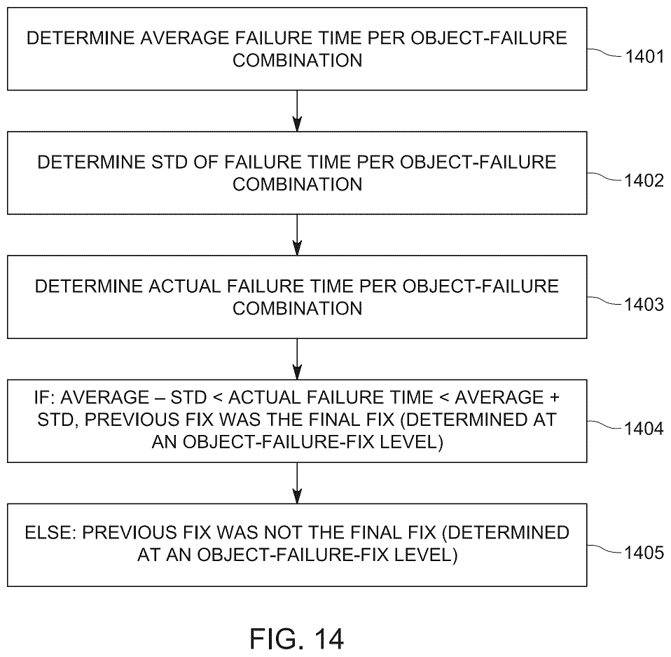

FIG. 14 depicts an exemplary process for determining a final fix.

At step 1401 an average failure time is determined based on an object-failure combination. This determination may be made by identifying all instances in the dataset of a particular combination of an object code and a failure mode at an aircraft level. In other words, a determination is made of how frequently the same issue occurred to the same object on the same airplane. Whether it is the same airplane is determined by the airplane ID data value. The determination of how frequently is made using the time data value for each data point to determine the amount of time that elapsed between each instance of the issue. The average failure time is then determined by averaging each failure time.

At step 1402, the standard deviation of the failure time is determined.

Next, at step 1403, the actual failure time is determined. The actual failure time is determined as the failure time between two consecutive instances of the same issue arising.

At step 1404, the actual failure time is checked to see whether it falls within one standard deviation of the average failure time. If the actual failure time is within one standard deviation of the average failure time, then the previous fix that was performed (as indicated by the action, the fix ATA code, or both), which is the fix that led to the failure time being within acceptable window (i.e., within one standard deviation), is determined to be the “final fix” for that particular object-failure combination.

At step 1405, if the failure time is outside the acceptable window (i.e., outside one standard deviation), then the previous fix is determined not to be the final fix.

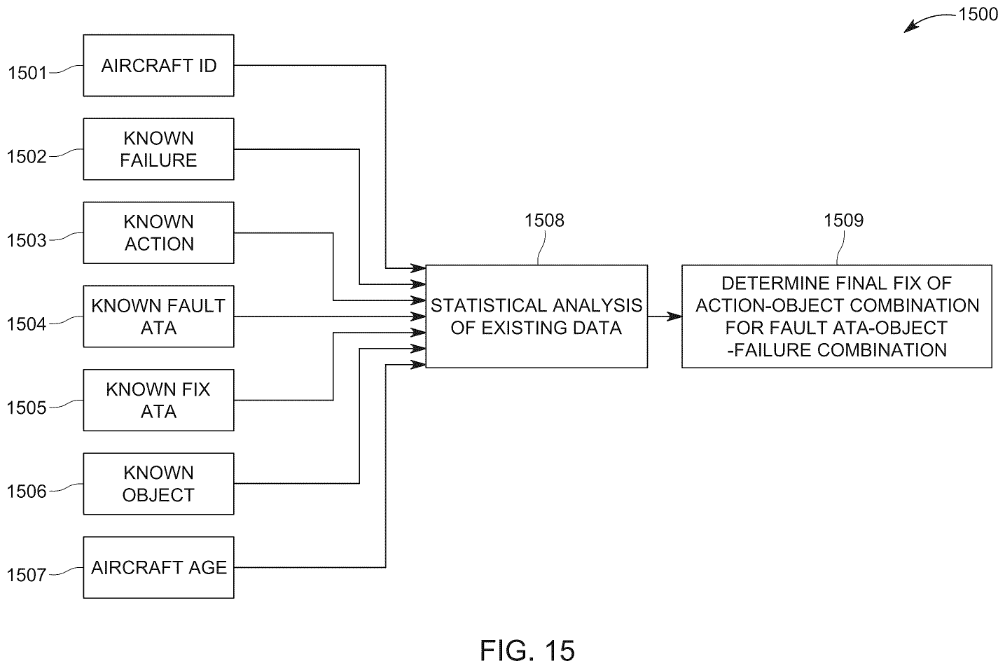

FIG. 15 depicts an exemplary process for determining a final fix for a given combination of fault ATA code, object, and/or failure mode. Referring to FIG. 15, a statistical analysis of existing data (process 1508) is performed using one or more of aircraft ID 1501, known failure 1502, known action 1503, known fault ATA code 1504, known fix ATA code 1505, known object code 1506, and/or aircraft age 1507.

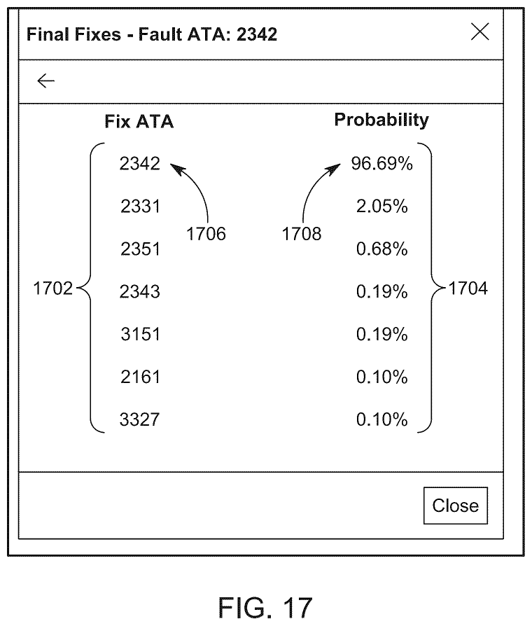

Aircraft ID 1501 refers to the specific airplane on which failure 1502, action 1503, fault ATA code 1504, fix ATA code 1505, and object code 1506 occurred. Aircraft age 1507 refers to the age (measured in time) of the aircraft referred to by aircraft ID 1501. The statistical analysis process 1508 is described in the context of FIG. 17.

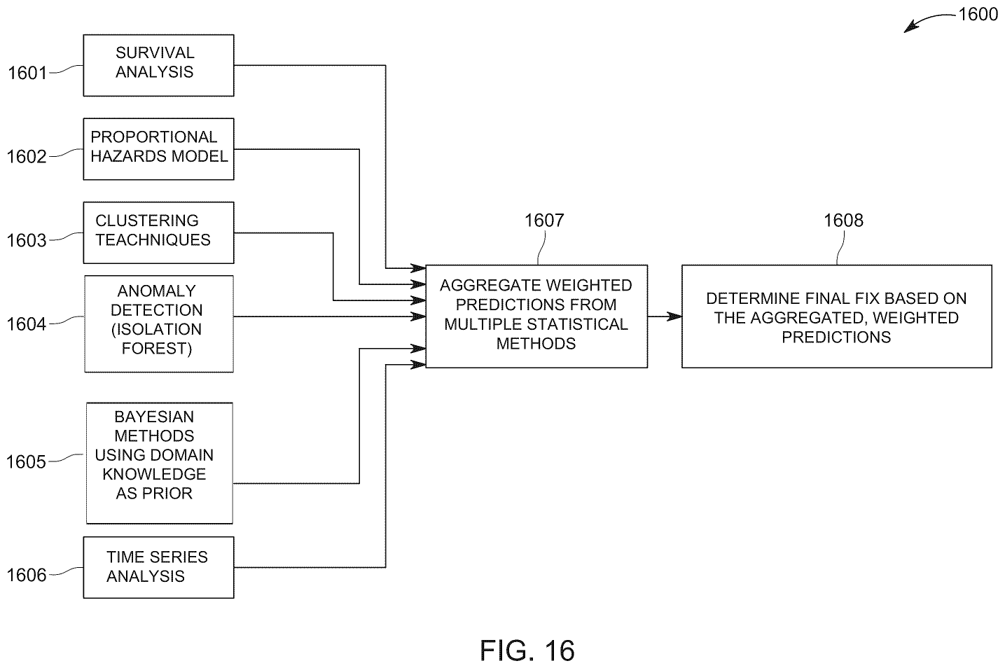

FIG. 16 depicts an exemplary process for determining a final fix that combines multiple statistical methods according to an embodiment of the subject matter described herein. As mentioned previously, a fix may be determined to be a final fix based on a variety of different statistical methods. The process 1600 determines whether a fix is final by employing an ensemble approach that combines multiple statistical methods, where each method generates an individual prediction regarding the finality of the fix.

Method 1601 employs survival analysis techniques for determining whether a fix is a final fix. This involves fitting a survival model, such as the Kaplan-Meier estimator, to historical fix lifetime data associated with the determined fault ATA code. The survival probability at the current fix lifetime is calculated, and if this probability falls below a predefined threshold (e.g., 5%), the fix is identified as a final fix.

Method 1602 utilizes a Cox proportional hazards model for determining whether a fix is a final fix. The model may be trained on historical fix data, incorporating various features such as fix type, aircraft age, environmental conditions, and usage patterns. By calculating the hazard ratio for the current fix and estimating its survival probability over time, the method identifies the fix as final if the survival probability at the current fix lifetime is below a chosen threshold.

Method 1603 applies clustering techniques to historical fix data for determining whether a fix is a final fix. By clustering fixes based on their lifetimes and other relevant features, the method identifies groups representing final and non-final fixes. The current fix is then assigned to a cluster, and if it belongs to the cluster associated with final fixes (e.g., the cluster with the longest average fix lifetime), it is identified as a final fix.

Method 1604 employs an Isolation Forest-based anomaly detection technique for determining whether a fix is a final fix. The method 1604 involves combining the fix lifetime with other relevant features to form feature vectors representing each historical fix. An Isolation Forest model is trained on this historical data to learn the normal patterns of fix lifetimes and associated features. The current fix is then evaluated using the trained model to compute an anomaly score and determine if it is an outlier. If the fix is identified as an outlier—deviating significantly from historical patterns—it is considered a final fix.

Method 1605 utilizes Bayesian statistical methods wherein domain knowledge sets the prior distribution for determining whether a fix is a final fix. The method involves defining a prior distribution of expected fix lifetimes based on domain knowledge, such as manufacturer guidelines or expert input on operational lifetimes for parts and systems associated with the fault ATA code. Historical fix lifetime data is then used to update this prior distribution, forming a posterior distribution that reflects both prior expectations and observed data. By calculating the probability that the fix lifetime exceeds the observed duration using the posterior distribution, the method identifies the fix as final if this probability is below a chosen threshold (e.g., 5%).

Method 1606 utilizing time series analysis for determining whether a fix is a final fix. By analyzing the sequence of past fix events and modeling the intervals between them using time series models (e.g., ARIMA), the method forecasts the expected time until the next fix. If the time elapsed since the last fix significantly exceeds this forecasted interval (e.g., by 50%), the fix is identified as final.

Step 1607 employs an ensemble approach that combines multiple statistical methods 1601-1606 for determining whether a fix is a final fix. Each method generates an individual prediction regarding the finality of the fix. This ensemble method enhances the robustness and adaptability of the final fix determination by leveraging the strengths of multiple statistical approaches and incorporating user feedback. As more feedback is collected over time, the weights can be updated to improve the overall accuracy and reliability of the ensemble prediction.

The ensemble method 1607 may begin by computing individual predictions from various statistical approaches. Weights may be retrieved for each statistical method (e.g., based on user feedback accumulated over time where this feedback reflects the historical accuracy, reliability, or user preference for each method) and the weights may be normalized to ensure they sum to one. Initial weights (prior to collecting user feedback) may be chosen via optimizing the fit to historical fix data.

The individual predictions may then be aggregated by calculating a weighted vote, where each prediction is multiplied by its corresponding weight derived from user feedback.

Step 1608 may include setting a decision threshold for classifying the fix as final or not. For example, the fix may be identified as a final fix if the weighted vote meets or exceeds the threshold (e.g., 0.5 in a binary classification scenario). Finally, the final determination based on the aggregated, weighted predictions may be output.

FIG. 17 depicts an example of a user interface showing the determination of a final fix as described in the context of FIGS. 13-15. Referring to FIG. 17, a plurality of actions associated with attempts to resolve a fault ATA code are shown. As can be seen, for a particular given fault ATA code, a list of possible fix ATA codes and their corresponding probabilities of being the final fix, as determined by the AI models, is displayed.

The probability of each action successfully resolving the fault ATA code is shown. As explained above, the AI models transform the text-based description(s) of the fault and fix into corresponding fault/fix information, which includes a fault ATA code and/or a fix ATA code.

Referring to FIG. 17, fault ATA code 2342 (as determined by the AI model) may be associated with a plurality of possible actions (fixes). Each possible fix may be identified by a fix ATA code. The possible fix ATA codes are shown as the group 1702.

The AI model may compare, for each action, a measure of relative effectiveness for each action. The measure of relative effectiveness may include calculating, for each action, the probability that the action resolved the ATA code. The measure of relative effectiveness is shown as the group 1704.

The most effective action is the action that, from among the one or more actions, has the highest probability of resolving the issue indicated by the ATA code. In the example shown in FIG. 14, fix ATA code 1706, which is 2342, has the highest probability 1408 of 96.69% of resolving fault ATA code 2342. This measure of effectiveness may be determined, for example, by having a standard deviation above a threshold value (e.g., 1) relative to the other actions. In some embodiments, the action determined to be the most effective, as well as the one or more other actions, and their associated measures of effectiveness may be provided to the user. This may be referred to as the “final fix” because it is the fix that, based on the available data, has the highest likelihood of resolving the problem.

In one embodiment, the final fix may be determined and implemented as follows. A desired Fault ATA is selected from the ML labeled dataset. This ML labeled dataset includes labels of fault ATA code, fix ATA code, action, object code, and failure mode (as shown, for example, in FIG. 7). The tagged dataset is separated into groups by airplane ID.

A new data column fix ID is created. The fix ID may be defined as the object code plus the action code (for example, “replace main tire/wheel assembly”).

A new data column time delta is created. The time delta may include any time span or other measure. For example, the time delta may refer to flight hours, in-service hours, part hours, part age, number of cycles for the part, or any other measurement of the wear or use of the part. The time delta value is determined as the difference between the current entry and the next (n+1) entry.

A new data column final fix is created. The final fix is determined as True (or “1”) if the time delta is greater than a pre-determined amount of time (e.g., 1 month) or False (or “0”) otherwise. In another embodiment, the final fix may be determined based on a standard deviation. For example, the final fix may be determined as True (or “1”) if the time delta is greater than a pre-determined standard deviation (e.g., one standard deviation) above the rest of the data.

In various embodiments, this data is aggregated across all airplane IDs, and the percentage of times that each fix ID is characterized as the final fix is reported. This provides additional information regarding which fix to a particular fault ATA code is most likely to resolve the problem for good.

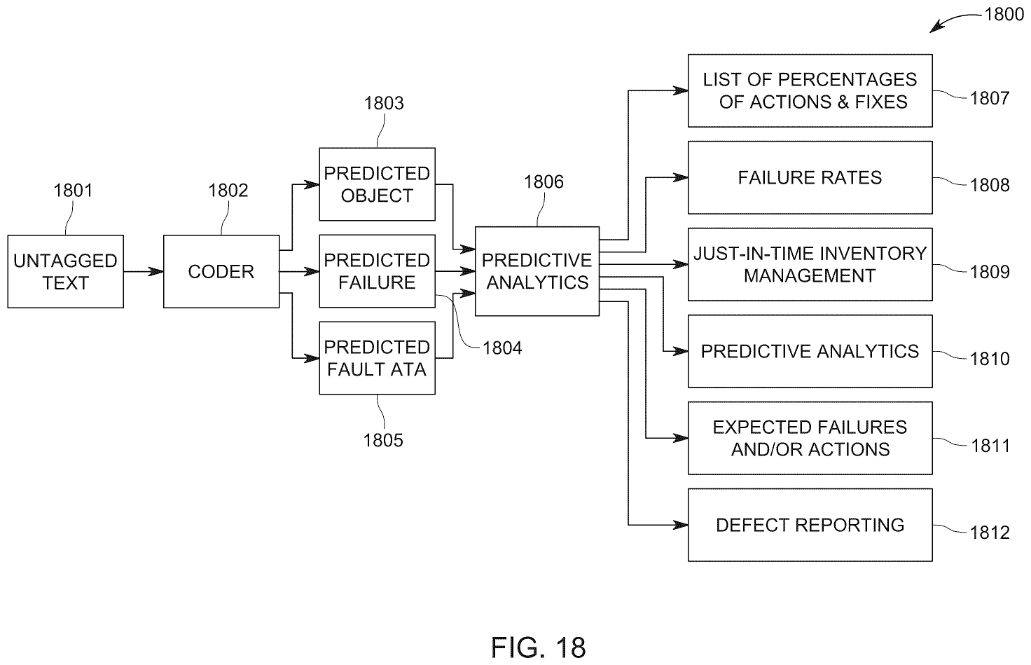

FIG. 18 depicts an exemplary process for determining predictive analytics using one or more of predicted object code, predicted failure mode, and/or predicted fault ATA code. Referring to FIG. 18, untagged text 1801 may be provided to the five fine-tuned models described herein. This is shown as coder 1802. The models code or tag the data based on the untagged 1801. Among other things, the coder 1802 generates a predicted object 1503, a predicted failure mode 1504, and a predicted fault ATA code 1805.

These predicted object, failure, and fault ATA codes are provided to a predictive analytics engine 1806, which provides various forward-looking analytic data. For example, a list of actions/fixes and their corresponding percentages of success is generated. This allows for real-time troubleshooting whereby a mechanic in the field enters the problem into the system and immediately gets a suggestion for the most likely fix.

Additionally, expected and actual failure rates are determined at a part-level, which allows for better understanding replacement cycles. Similarly, inventory management is handled on a forward-looking basis. The inventory management may be based on a mechanic's notes. For example, when a mechanic (or somebody else, such as the pilot during a pre-flight check) inputs an identified problem, the likely source of the problem and a corresponding likely fix for the problem is identified, and a replacement part can be ordered to arrive at a location for installation in the airplane corresponding to the airplane's upcoming schedule. In other words, a mechanic makes a note of an issue in the system, and when the plane lands at its next destination, the likely replacement part for that issue is waiting at that destination ready to be installed.

Similarly, forward-looking failures are predicted. The system can identify when a part is likely to fail, even before it has actually failed, which allows for preventative maintenance, as well as ordering of replacement parts ahead of the actual failure.

Finally, in an embodiment, the systems and methods described herein may identify defects for reporting. The reporting may be internal reporting, for example, to the airlines. The reporting may be external reporting, for example, to governmental and/or regulatory bodies that require such reports, such as the Federal Aviation Administration (FAA) or the National Transportation Safety Board (NTSB).

In one embodiment, the systems and methods described herein may use the AI model to identify certain codes or other faults that need to be reported to a regulatory body. The systems and methods described herein generate a report based on the identified codes or faults that need to be reported. The automatically generated report may include, for example, the OperatorControlNumber. The OperatorControlNumber is a user-defined unique identifier. It begins with the first four alphanumeric characters of the submitter's certificate number (Designator). The next eight numbers represent the date when the serious defect report (SDR) is submitted (in yyyymmdd format). The remaining numbers represent a submitter-designed numbering system.

The report may further include DifficultyDate, which is the date the problem occurred. The report may further include OperatorDesignator, which is the designator of the operator of the aircraft. The report may further include SubmitterDesignator, which is the designator of the company submitting the SDR. This may be different from the OperatorDesignator in the case of Repair Stations. The report may further include SubmitterTypeCode. The report may further include SDRType, which is “G” for a general aviation-related SDR or “A” for an air carrier-related SDR.

The report may further include NatureOfConditionA, which is a nature of condition code. The report may further include StageOfOperationCode, which is a stage of operation code. The report may further include RegistryNumber, which is the aircraft registration number.

The report may further include AircraftMake, which is an FAA (SIT) aircraft make code. The report may further include AircraftModel, which is an FAA (SIT) aircraft model code.

The report may further include PartMake, which is an FAA (SIT) part make (name of manufacturer) code. The report may further include PartCondition. The report may further include ComponentMake, which is an FAA (SIT) component make (name of manufacturer) code. The report may further include ComponentTimeSince, which is the time the component has been in service since its most recent overhaul, repair, or inspection.

The report may further include Discrepancy, which describes the conditions subsequent to, or leading up to, the reported problem. The Discrepancy may identify the cause for malfunction and emergency measures executed, and may include compliance or non-compliance with airworthiness directives, service bulletins, STCs, and PMAs, and may include any significant facts that may be helpful to reduce or eliminate recurrence (i.e., cycles, landings, and suggested changes).

The systems and methods described herein may automatically create a connection to the FAA's reporting website and automatically log into that reporting website to upload the automatically generated report.

The total system (the one that does analytics about the final fixes for an ATA and shows fleet-wide trends. The final fix determination and the fleet-wide trends is built using data from the ATA/Fix Coder.

The description and figures are illustrative and are not to be construed as limiting. Numerous specific details are described to provide a thorough understanding of the disclosure. Reference in this specification to “one embodiment” or “an embodiment” means that a particular feature, structure, or characteristic described in connection with the embodiment is included in at least one embodiment of the disclosure. Multiple appearances of the phrase “in one embodiment” in various places in the specification are not necessarily all referring to the same embodiment, nor are separate or alternative embodiments mutually exclusive of other embodiments.

The terms used in this specification generally have their ordinary meanings in the art, within the context of the disclosure, and in the specific context where each term is used. Alternative language and synonyms may be used for any one or more of the terms discussed herein, nor is any special significance to be placed upon whether or not a term is elaborated or discussed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable medium(s) having computer readable program code embodied thereon.

Machine learning-based software may load data in an unstructured format and automatically determine relationships between the data. Machine learning-based software may include a model generator, a training data module, a model processor, a model memory, and a communication device. Machine learning-based software may be configured to create prediction models based on the training data using artificial neural networks and/or deep learning algorithms. Machine learning-based software may also calculate coefficients and hyper parameters of a model based on the training data set. Machine learning-based software may utilize hardware optimized for machine learning functions, such as an FPGA. In certain embodiments, machine learning-based software may use supervised or unsupervised learning techniques. Transformer models may be used for processing data for natural language processing (NLP) tasks like text translation and summarization by parallelly processing input. Transformer-based NLP models, such as bidirectional encoder representations from transformers (BERT), may be pre-trained on pre-training data sets.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor which executes computer program instructions for implementing the functions/acts specified in the flowchart and/or block diagram block or blocks. The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

As used herein, the singular forms “a,” “an” and “the” are intended to include the plural forms as well, unless the context clearly indicates otherwise. It will be further understood that the terms “comprises” and/or “comprising,” do not preclude the presence or addition of one or more other features, integers, steps, operations, elements, components, and/or groups thereof.

What is claimed is:

1. A method for coding airline fault codes, the method comprising:
providing a transformer-based natural language processing (NLP) artificial intelligence (AI) model trained on a dataset, wherein the dataset includes a plurality of text strings tagged with at least one associated air transport association (ATA) code;
receiving an untagged text string;
automatically tagging the text string including determining an associated Fault ATA code by providing the text string as input to the trained AI model;
providing the determined Fault ATA code as an input to a machine-learning model, wherein the machine-learning model further identifies a Fix ATA code, a Failure Mode, an Object Code, and an Action Code based on the determined Fault ATA code; and
identifying a final fix for the determined Fault ATA, wherein the final fix is identified based on a time value representing time between similar Fault ATAs occurring within a particular aircraft.

2. The method of claim 1, wherein the text string is a natural language description of a repair or maintenance record of large machinery including aircraft.

3. The method of claim 1, wherein training the AI model on the training dataset includes:
separating the training dataset into one or more ATA code-specific datasets;
creating a separate instance of the AI model for each ATA code; and
individually training each instance of the AI model on one of the ATA code-specific datasets.

4. The method of claim 1, wherein the training dataset includes one or more actions associated with at least one of the ATA codes, and training the AI model further includes comparing, for each action, a measure of relative effectiveness for each action.

5. The method of claim 4, wherein determining the measure of relative effectiveness includes calculating, for each action, a probability that the action resolved the ATA code.

6. The method of claim 5, identifying the most effective action, from among the one or more actions, wherein the most effective action has the highest probability that the action resolved an issue indicated by the ATA code and wherein the most effective action has a standard deviation above a threshold value relative to other actions.

7. The method of claim 1, wherein identifying the final fix for the determined Fault ATA includes fitting a survival model to historical fix lifetime data associated with the determined fault ATA code and identifying a fix as the final fix in response to determining that a survival probability at a current fix lifetime is below a predefined threshold.

8. The method of claim 7, wherein survival model includes a Kaplan-Meier estimator.

9. The method of claim 1, wherein identifying the final fix for the determined Fault ATA includes:
training the AI model on historical fix data;
calculating a hazard ratio for a fix;
estimating a survival probability of the fix over time; and
determining whether the survival probability at a current fix lifetime is below a predetermined threshold.

10. The method of claim 9, wherein the historical fix data includes at least one of: a fix type, an aircraft age, environmental conditions, and usage patterns.

11. The method of claim 1, wherein identifying the final fix for the determined Fault ATA includes:
clustering fixes based on their lifetimes, wherein clusters identify groups representing final and non-final fixes;
assigning a fix to a cluster; and
identifying the fix as the final fix in response to determining that the fix is assigned to the cluster with the longest average fix lifetime.

12. The method of claim 1, wherein identifying the final fix for the determined Fault ATA includes:
forming feature vectors based at least on a fix lifetime and the feature vectors representing each historical fix.
training an Isolation Forest model on this historical data to learn the normal patterns of fix lifetimes and associated features.
evaluating the fix using the trained Isolation Forest model to compute an anomaly score;
determining if it is an outlier; and
identifying a fix as the final fix in response to determining that the fix is an outlier deviating significantly from historical patterns.

13. The method of claim 1, wherein identifying the final fix for the determined Fault ATA includes:
defining a prior distribution of expected fix lifetimes based on manufacturer guidelines on operational lifetimes for parts and systems associated with the fault ATA code;
updating the prior distribution using historical fix lifetime data to form a posterior distribution that reflects both prior expectations and observed data;
calculating a probability that the fix lifetime exceeds an observed duration using the posterior distribution; and
identifying a fix as the final fix in response to the probability is below a predetermined threshold.

14. The method of claim 1, wherein identifying the final fix for the determined Fault ATA includes:
modeling intervals between a sequence of past fix events using a time series model;
forecasting an expected time until the next fix based on the model; and
identifying a fix as the final fix in response to the time elapsed since the last fix significantly exceeds this forecasted interval.

15. The method of claim 1, wherein identifying the final fix for the determined Fault ATA includes identifying a fix as the final fix based on aggregated, weighted predictions from multiple statistical methods that each statistical generate an individual prediction regarding the finality of the fix, which includes:
computing individual predictions from the each of the multiple statistical methods;
retrieving weights for each statistical method that reflect a historical accuracy, reliability, or user preference for each method;
normalizing the weights;
calculating a weighted vote by multiplying the predictions from the each of the multiple statistical methods by the corresponding weight;
classifying the fix as final based on a predetermined threshold; and
identifying a fix as the final fix in response to the weighted vote being equal to or greater than the threshold.

16. The method of claim 1, further comprising determining a probability that a system, sub-system, assembly, sub-assembly, component, service, item, or part associated with a received ATA code is likely to fail within a predefined time period.

17. The method of claim 16, further comprising automatically ordering a system, a sub-system, an assembly, a sub-assembly, a component, a service, an item, or a part based on the probability of failure.

18. The method of claim 16, further comprising at least one of escalating or de-escalating a service interval based on the probability of failure.

19. A system for coding airline fault codes, the system comprising:
a processor and memory for:
providing a transformer-based natural language processing (NLP) artificial intelligence (AI) model trained on a dataset, wherein the dataset includes a plurality of text strings tagged with at least one associated air transport association (ATA) code;
receiving an untagged text string;
automatically tagging the text string that includes determining an associated Fault ATA code upon providing the text string as input to the trained AI model;
providing the determined Fault ATA code as an input to a machine-learning, wherein the machine-learning model further identifies a Fix ATA code, a Failure Mode, an Object Code, and an Action Code based on the determined Fault ATA code; and
identifying a final fix for the determined Fault ATA, wherein the final fix is identified based on a time value representing time between similar Fault ATAs occurring within a particular aircraft.

20. A computer program product for AI tagging of airline fault codes, the computer program product comprising:
a computer readable storage medium having computer readable program code embodied therewith, the computer readable program code comprising computer readable program code configured for:
providing a transformer-based natural language processing (NLP) artificial intelligence (AI) model trained on a dataset, wherein the dataset includes a plurality of text strings tagged with at least one associated air transport association (ATA) code;
receiving an untagged text string;
automatically tagging the text string that includes determining an associated Fault ATA code upon providing the text string as input to the trained AI model;
providing the determined Fault ATA code as an input to a machine-learning model, wherein the machine-learning model further identifies a Fix ATA code, a Failure Mode, an Object Code, and an Action Code based on the determined Fault ATA code; and
identifying a final fix for the determined Fault ATA, wherein the final fix is identified based on a time value representing time between similar Fault ATAs occurring within a particular aircraft.
